(19) United States
(12) Patent Application Publication
(10) Pub. No.: US 2026/0177724 A1
(43) Pub. Date: Jun. 25, 2026

(54) Circuit Module Used in Weather Station and Weather Station

(71) Applicant: Fuzhou Clearvue Intelligent Technology Co., Ltd, Fuzhou (CN)

(72) Inventor: Yunhua Shen, Lichuan (CN)

(21) Appl. No.: 19/014,037

(22) Filed: Jan. 8, 2025

(30) Foreign Application Priority Data
Dec. 24, 2024 (CN) 2024231999143

(51) Int. Cl. G01W 1/06

(52) U.S. Cl. CPC G01W 1/06

(57) ABSTRACT

The present invention provides a circuit module used in weather station and weather station. The circuit module includes a microcontroller, a display circuit, a humidity detection circuit, a temperature detection circuit, a power supply circuit and a wireless communication circuit. The power supply circuit is electrically connected to the microcontroller and the wireless communication circuit. The microcontroller is electrically connected to the display circuit, the temperature detection circuit, the humidity detection circuit and the wireless communication circuit. The weather station includes the said circuit module. Users can directly connect the weather station to a terminal device and set the weather station without downloading an application software.

### CROSS-REFERENCE TO RELATED APPLICATIONS

The present application claims the benefit of Chinese Patent Application No. 2024231999143 filed on Dec. 24, 2024, the contents of which are hereby incorporated by reference.

### TECHNICAL FIELD

The present application belongs to the technical field of weather station, and particularly relates to a circuit module used in weather station and weather station.

### TECHNICAL BACKGROUND

A weather station for home use is a device used to monitor and record the weather environment around the home to help users understand the local climate conditions. Its main functions include displaying the current time, temperature and humidity. Some multifunctional weather stations also have the function of predicting future weather.

At present, the weather station for home use is usually placed in a certain location in the home, and users need to move to the location to view detailed information. If users need to view the information of the weather station on the mobile device anytime and anywhere, they need to download the corresponding application software and associate the weather station through the application software to realize real-time monitoring of the weather station.

### INVENTION CONTENT

In order to overcome the defects of the existing technology, the present application provides a circuit module used in weather station and weather station. The weather station comprises the circuit module. The weather station can be directly connected to a terminal device. Users can also set the weather station without downloading application software.

The technical scheme adopted by the present application for solving the technical problems is as follows:

A circuit module used in weather station, includes a microcontroller, a display circuit, a humidity detection circuit, a temperature detection circuit, a power supply circuit and a wireless communication circuit. The power supply circuit is electrically connected to the microcontroller and the wireless communication circuit; the microcontroller is electrically connected to the display circuit, the temperature detection circuit, the humidity detection circuit and the wireless communication circuit; the power supply circuit is used to provide an operation voltage for the wireless communication circuit and the microcontroller; the wireless communication circuit is used to connect the microcontroller and an external terminal device; the humidity detection circuit is used to detect humidity data in the environment and transmit the humidity data to the microcontroller; the temperature detection circuit is used to detect temperature data in the environment and transmit the temperature data to the microcontroller; the microcontroller is used to control the opening and closing of the display circuit.

Further, the microcontroller includes a control chip U1, a resistor R5, a capacitor C3, a capacitor C4 and a crystal oscillator Y1. The control chip U1 has 28 pins. Pins 1 and 12 of the control chip U1 are connected to the power supply circuit, and pin 18 of the control chip U1 is connected to the power supply circuit through the resistor R5. The node between pin 18 of the control chip U1 and the resistor R5 is connected to one end of the capacitor C4, and the other end of the capacitor C4 is grounded. Pin 17 of the control chip U1 is grounded after passing through the capacitor C3, the node between pin 17 of the control chip U1 and the capacitor C3 is connected to one end of the crystal oscillator Y1, and the other end of the crystal oscillator Y1 is connected to pin 16 of the control chip U1.

Further, the wireless communication circuit includes a wireless module and a capacitor C17. The wireless module has 35 pins, and pin 3 of the wireless module is grounded after passing through the capacitor C17. The node between the capacitor C17 and pin 3 of the wireless module is connected to the power supply circuit. Pin 8 of the wireless module is connected to pin 11 of the control chip U1, and pin 18 of the wireless module is connected to pin 10 of the control chip U1; pin 19 of the wireless module is connected to pin 9 of the control chip U1.

Further, the power supply circuit includes a battery, a power port, a diode D1, a diode D2, a linear regulator and a buck converter. The input end of the power port is connected to an external power supply device, and the output end transmits the voltage to the diode D1 and the linear regulator U6 and then is connected to the control chip U1; the cathode of the battery is grounded, and the anode of the battery is connected to the control chip U1 after passing through the diode D2 and the linear regulator.

Further, the power supply circuit also includes a buck converter U8 and a capacitor C20. The node between the diode D1 and the linear regulator U6 is connected to the input end of the buck converter U8. The output end of the buck converter U8 is connected to the wireless communication circuit. One end of the capacitor C20 is connected to the node between the diode D1 and the buck converter U8, and the other end of the capacitor C20 is grounded.

Further, the temperature detection circuit includes a thermistor RT, a resistor R1, a resistor R2, a resistor R3, a resistor R4 and a capacitor C5. One end of the thermistor RT is connected to the power supply circuit through the resistor R3, the other end of the thermistor RT is connected to pin 3 of the control chip U1 through the resistor R1. The node between the thermistor RT and the resistor R1 is connected to pin 4 of the control chip U1. The resistor R2 is connected in parallel to two ends of the thermistor RT, and the resistor R4 is connected in parallel to two ends of the resistor R1. One end of the capacitor C5 is grounded, and the other end is connected to the node between the resistor R1 and the control chip U1.

Further, the humidity detection circuit includes a humidity sensor RH, a resistor R32, a resistor R33, a resistor R34, a resistor R35, a resistor R36, a resistor R37 and a capacitor C30. One end of the humidity sensor RH is connected to pin 7 of the control chip U1 through the resistor R35, the other end of the humidity sensor RH is connected to pin 5 of the control chip U1 through the resistor R32. The node between the resistor R32 and the humidity sensor RH is connected to pin 6 of the control chip U1. The resistor R33 is connected in parallel to two ends of the humidity sensor RH, the resistor R34 is connected in parallel to two ends of the resistor R32. One end of the capacitor C30 is grounded, and the other end is connected to the node between the resistor R34 and the control chip U1. One end of the resistor R36 and the resistor R37 connected in parallel is connected to the node between the capacitor C30 and the control chip U1, and the other end is connected to pin 8 of the control chip U1.

Further, the circuit module also includes a buzzer circuit, which comprises a field-effect transistor Q6, a resistor R21, a resistor R38 and a buzzer. The source of the field-effect transistor Q6 is grounded, the gate of the field-effect transistor Q6 is connected to pin 28 of the control chip U1 through the resistor R38, the drain of the field-effect transistor Q6 is connected to the buzzer through the resistor R21, and the buzzer is connected to the power supply circuit.

Further, the present application also provides a weather station, including a cover which has an inner cavity. A circuit board is arranged in the inner cavity, a circuit module as described in any one of Claims 1 to 8 is welded on the circuit board. An LED nexie tube is arranged above the circuit board, and a facet is arranged above the LED nexie tube.

Further, a battery case is arranged at the bottom of the cover, a battery is arranged inside the battery case, and the battery is electrically connected to the circuit board.

The beneficial effects of the present application:

The present application provides a circuit module used in weather station and weather station. The weather station comprises the circuit module, and the circuit module comprises a wireless communication circuit. Through the wireless communication circuit. Users can directly connect the weather station to a terminal device and set the weather station without downloading an application software.

### DESCRIPTION OF FIGURES

FIG. 1 is a circuit structure diagram of a control chip U1 in the present application;

FIG. 2 is a circuit structure diagram of a power supply circuit in the present application;

FIG. 3 is a circuit structure diagram of a wireless communication circuit in the present application;

FIG. 4 is a circuit structure diagram of a light-emitting drive circuit in the present application;

FIG. 5 is a circuit structure diagram of a long display circuit in the present application;

FIG. 6 is a circuit structure diagram of a temperature detection circuit in the present application;

FIG. 7 is a circuit structure diagram of a humidity detection circuit in the present application;

FIG. 8 is a circuit structure diagram of the control chip U2 in the present application;

FIG. 9 is a circuit structure diagram of the control chip U3 in the present application;

FIG. 10 is a circuit structure diagram of the light-emitting circuit in the present application;

FIG. 11 is a circuit structure diagram of a buzzer circuit in the present application;

FIG. 12 is a circuit structure diagram of the button circuit in the present application;

FIG. 13 is a circuit structure diagram of the touch circuit in the present application;

FIG. 14 is a schematic view of the use status of the weather station in the present application;

FIG. 15 is an axonometric view of the weather station in the present application;

FIG. 16 is a bottom schematic view of the weather station in the present application;

FIG. 17 is an exploded view of the weather station in the present application;

Description of marks in figures:
1—Weather Station; 11—Cover; 111—inner cavity; 12—circuit board; 13—LED segment displays; 14—facet; 15—button; 16—power port; 17—battery case; 171—battery.

### DETAILED DESCRIPTION OF THE EMBODIMENTS

Below is a further detailed description of the present application based on the figures.

The present embodiment only shows an explanation of the present application and it is not a limitation to the present application. The skilled in the art can make modifications to this embodiment as needed without making any creative contributions after reading this specification, which are always protected by the patent law as long as they are within the scope of the claims of the present application.

It should be noted that when an element is called as being “fixed to” or “arranged on” another element, it can be directly on the other element or indirectly on the other element. When an element is called as being “connected to” another element, it can be directly connected to the other element or indirectly connected to the other element.

It should be noticed that the terms “length”, “width”, “above”, “below”, “front”, “rear”, “left”, “right”, “vertical”, “horizontal”, “top”, “bottom”, “inside” and “outside” which indicates the orientations or positional relationships are based on the orientations or positional relationships shown in the figures. They are only for facilitating describing the present application and simplifying the description, rather than indicating or implying that the device or component must have a specific orientation, construct and operate in a specific orientation, therefore, it understood as a limitation of the present application.

In addition, the terms “first” and “second” are used for descriptive purposes only and cannot be understood as indicating or implying relative importance or implicitly indicating the quantity of indicated technical features. Therefore, a feature defined as “first” and “second” may explicitly or implicitly include one or more of these features. In the description of the present application, “a plurality of” means two or more, unless otherwise specifically defined.

The present application provides a circuit module used in weather station and weather station. The weather station includes the circuit module, and the circuit module includes a wireless communication circuit. The weather station and a terminal device can be directly connected through the wireless communication circuit. Users can also set the weather station without downloading application software.

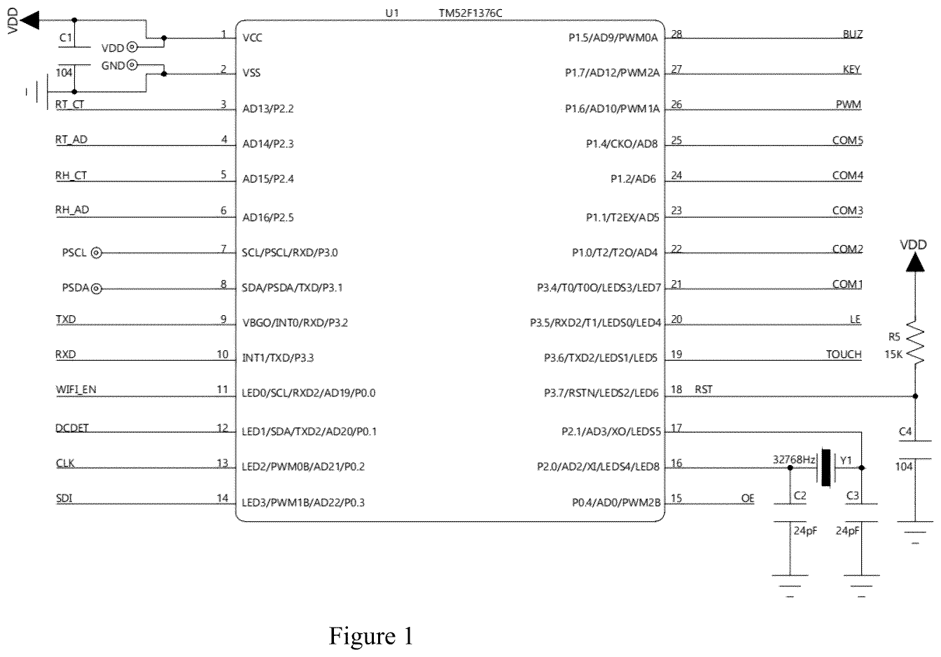

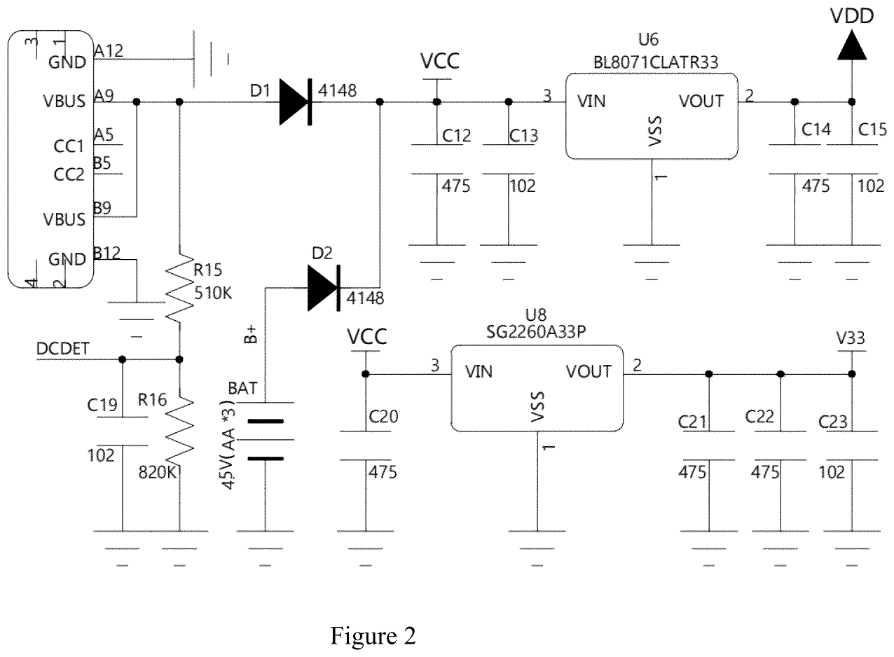

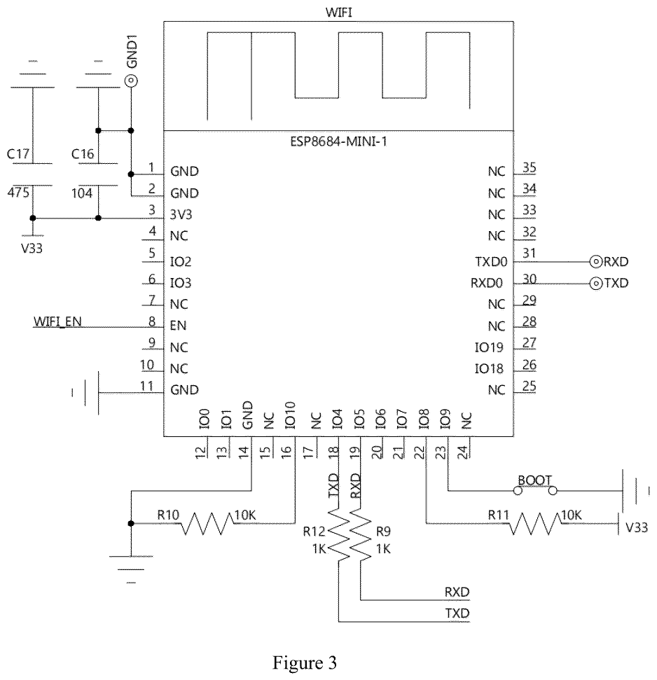

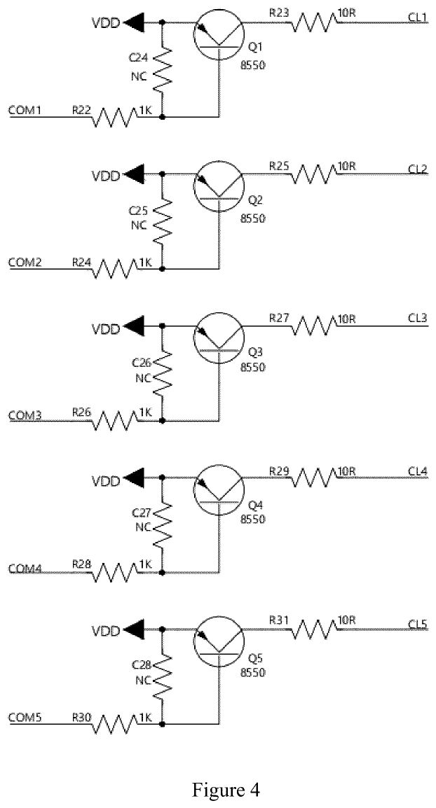

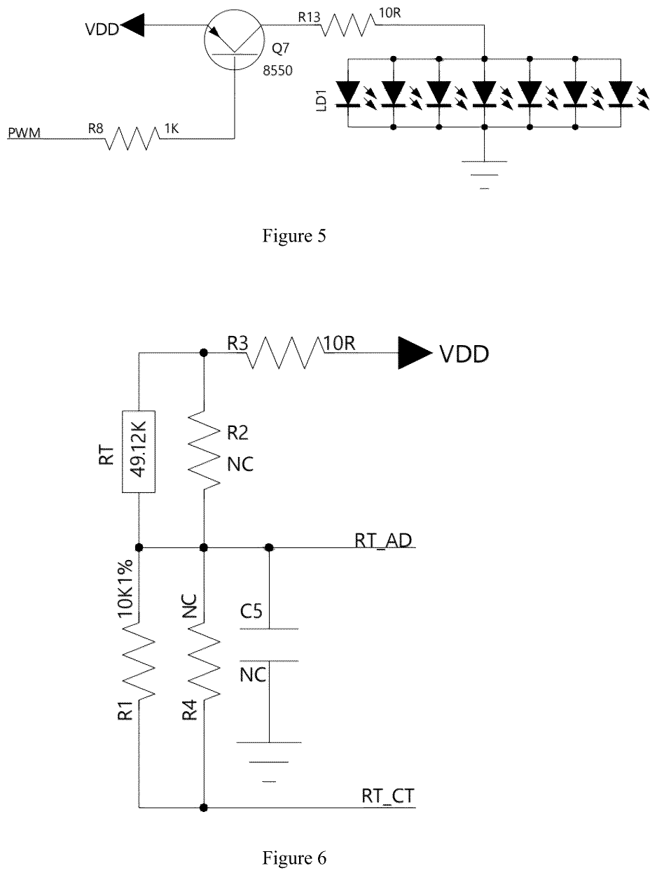

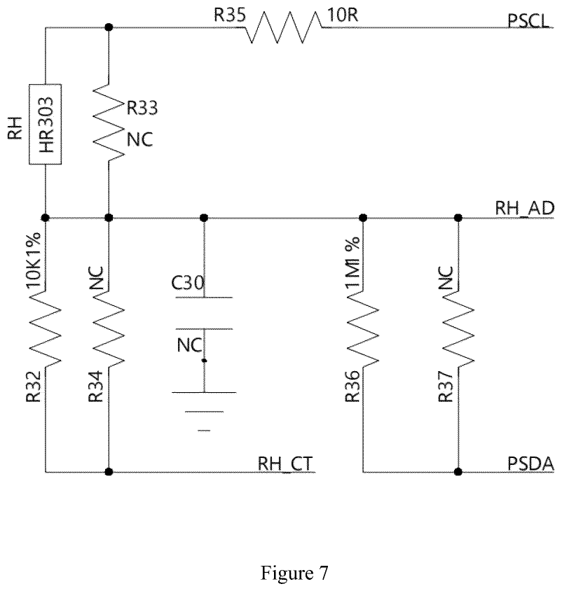

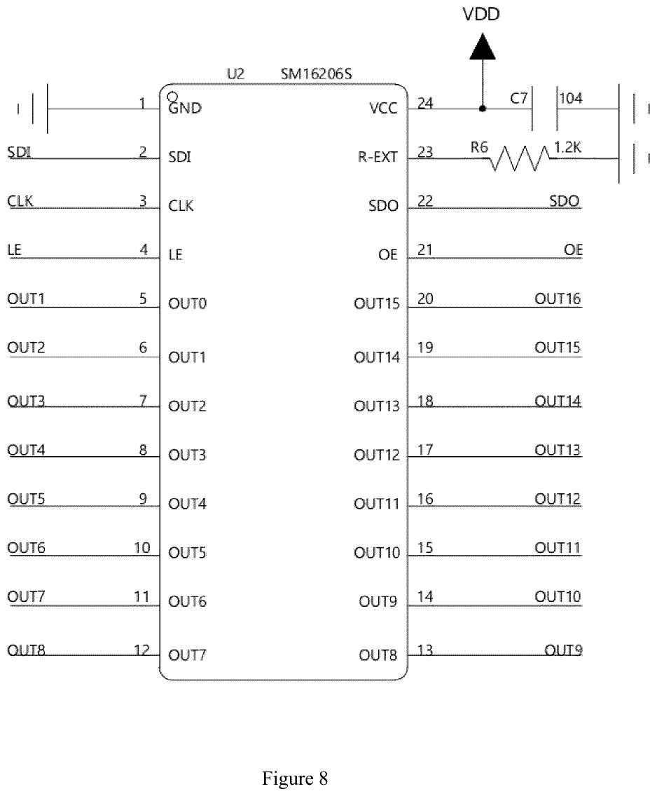

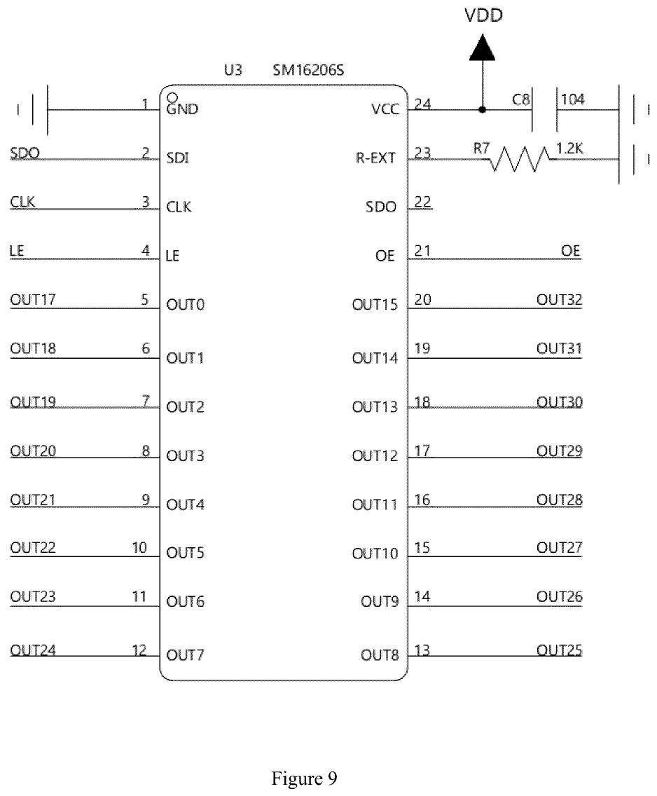

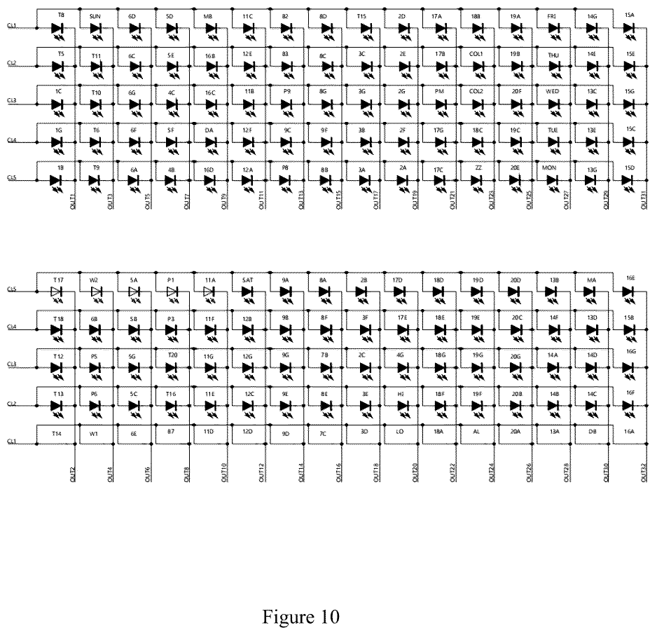

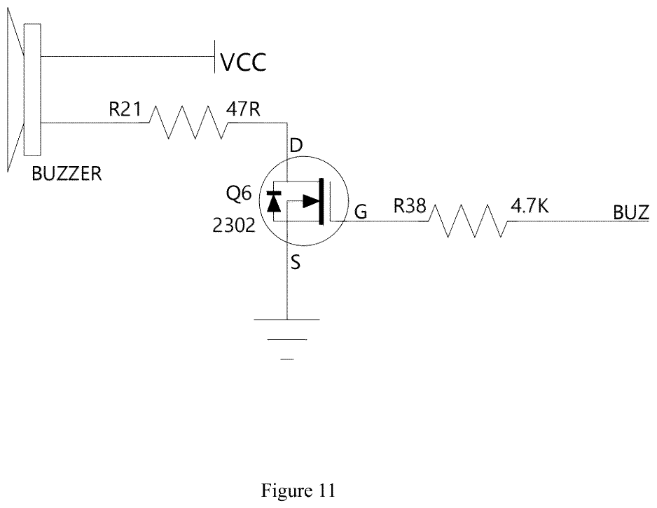

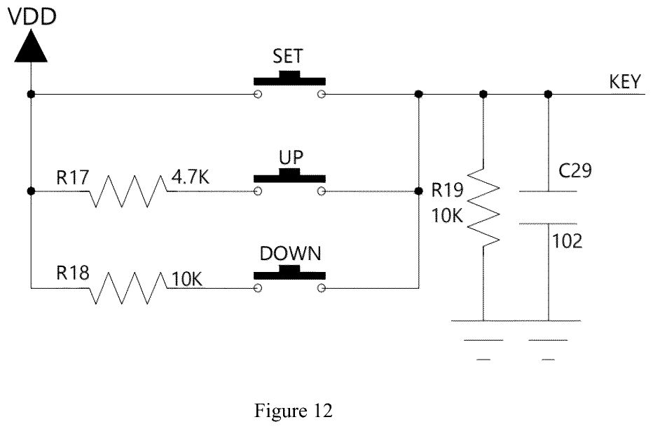

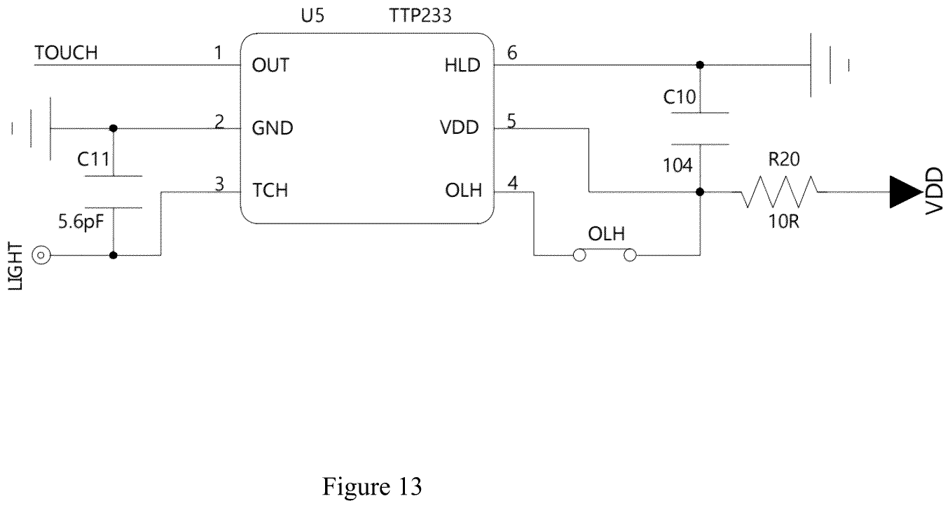

Referring to FIGS. 1 to 13, this embodiment provides a circuit module used in weather station, including a microcontroller, a display circuit, a humidity detection circuit, a temperature detection circuit, a power supply circuit and a wireless communication circuit. The power supply circuit is electrically connected to the microcontroller and the wireless communication circuit, and the microcontroller is electrically connected to the display circuit, the temperature detection circuit, the humidity detection circuit and the wireless communication circuit.

Among them, the power supply circuit is used to provide operation voltage for the wireless communication circuit and the microcontroller; the wireless communication circuit is used to connect the microcontroller and the external terminal device; the humidity detection circuit is used to detect the humidity data in the environment and transmit the humidity data to the microcontroller, and the temperature detection circuit is used to detect the temperature data in the environment and transmit the temperature data to the microcontroller; the microcontroller controls the opening and closing of the display circuit, and when the display circuit is opened, it can display the current weather information.

In this embodiment, the microcontroller includes a control chip U1, a resistor R5, a capacitor C3, a capacitor C4 and a crystal oscillator Y1. The control chip U1 has 28 pins. Pins 1 and 12 of the control chip U1 are connected to the power supply circuit. Pin 18 of the control chip U1 is connected to the power supply circuit through the resistor R5. The node between pin 18 of the control chip U1 and the resistor R5 is connected to one end of the capacitor C4. The other end of the capacitor C4 is grounded. Pin 17 of the control chip U1 is grounded through the capacitor C3. The node between pin 17 of the control chip U1 and the capacitor C3 is connected to one end of the crystal oscillator Y1. The other end of the crystal oscillator Y1 is connected to pin 16 of the control chip U1. The control chip U1 has a built-in clock circuit. The crystal oscillator Y1 uses the piezoelectric effect of the quartz crystal and works in a resonant state. It can provide stable and accurate single-frequency oscillation and can provide a stable clock signal for the clock circuit of the control chip U1 to synchronize operations.

Further, the microcontroller also includes a control chip U2 and a control chip U3, and the models of the control chip U2 and the control chip U3 are both SM16206S. Pin 1 of the control chip U2 is grounded, pin 24 is connected to the power supply circuit, pin 2 of the control chip U2 is connected to pin 14 of the control chip U1, pin 3 of the control chip U2 is connected to pin 13 of the control chip U1, pin 4 of the control chip U2 is connected to pin 20 of the control chip U1, pin 21 of the control chip U2 is connected to pin 15 of the control chip U1, and pin 22 of the control chip U2 is connected to pin 2 of the control chip U3.

The wireless communication circuit includes a wireless module and a capacitor C17. The wireless module in this embodiment uses the ESP8684-MINI-1 module, and the wireless module has 35 pins. Pin 3 of the wireless module is grounded through capacitor C17, and the node between capacitor C17 and pin 3 of the wireless module is connected to the power supply circuit; when pin 3 of the wireless module receives a high level, the wireless module is in working state; when pin 3 of the wireless module receives a low level, the wireless module is closed.

Pin 8 of the wireless module is connected to pin 11 of the control chip U1. Pin 18 of the wireless module is used as a data sending pin and is connected to pin 10 of the control chip U1 for receiving data. Pin 19 of the wireless module is used as a data receiving pin and is connected to pin 9 of the control chip U1 for sending data. Through cross-connection, two-way communication between the wireless module and the control chip U1 can be achieved. In addition, pin 30 of the wireless module is connected to the receiving end of the terminal device as a data sending pin, and pin 31 of the wireless module is connected to the sending end of the terminal device as a data receiving pin, so as to achieve cross-communication between the wireless module and the terminal device. Users can observe the weather information of the weather station at any time through the terminal device, or adjust and calibrate the weather information of the weather station through the terminal device.

The power supply circuit includes a battery, a power port, a diode D1, a diode D2, a linear regulator and a buck converter. The input end of the power port is connected to an external power supply device, and the output end transmits the voltage to the diode D1 and the linear regulator U6 and then is connected to the control chip U1, which is used to provide an operation voltage for the control chip U1; the cathode of the battery is grounded, and the anode of the battery is connected to the control chip U1 through the diode D2 and the linear regulator, which is used to provide an operation voltage for the control chip U1. Among them, the diode D1 has a rectifying effect, and the linear regulator U6 has a voltage-stabilizing effect, which can provide a stable operation voltage for the control chip U1.

Further, the power supply circuit also includes a buck converter U8 and a capacitor C20. The node between the diode D1 and the linear regulator U6 is connected to the input end of the buck converter U8, the output end of the buck converter U8 is connected to the wireless module. One end of the capacitor C20 is connected to the node between the diode D1 and the buck converter U8, and the other end of the capacitor C20 is grounded. The voltage output by the power port or the battery is rectified by the diode D1 or D2, and then converted into an operation voltage adapted to the wireless module by the buck converter U8, and finally transmitted to the wireless module to provide an operation voltage for the wireless module.

Preferably, the display circuit includes a light-emitting driving circuit and a light-emitting circuit. The light-emitting driving circuit comprises triodes Q1, Q2, Q3, Q4 and Q5. The light-emitting circuit comprises two LED diode arrays. The LED diode array is a matrix structure composed of multiple light-emitting diodes, arranged in a 5*16 manner. And the anode of each row of the light-emitting diodes is connected to the base of the same triode in the light-emitting driving circuit, and the cathode of each column of the light-emitting diodes is connected to the control chip U2 or the control chip U3. Compared with conventional electronic display screens, this embodiment uses multiple light-emitting diodes to display weather information, which has the advantages of longer service life and lower power consumption.

Here, the first row and the first column of the LED diode array are used as examples to illustrate:

The anodes of the light-emitting diodes in the first row of the LED diode array are connected to the base of the triode Q1, and the cathodes of the light-emitting diodes in the first column of the LED diode array are connected to the pin 6 of the control chip U2. Further, the emitter of the triode Q1 is connected to the output end of the power supply circuit, and the collector of the triode Q1 is connected to the pin 21 of the control chip U1. When the control chip U1 outputs a high level to the light-emitting drive circuit, the triode Q1 is turned on. At the same time, the control chip U2 outputs a low level to the cathode of the light-emitting diode in the light-emitting unit, the light-emitting diodes in the LED diode array are turned on, and the first row and the first column of the LED diode array are displayed; when the control chip U1 outputs a high level to the light-emitting drive circuit, the triode Q1 is turned on; at the same time, the control chip U2 outputs a high level to the cathode of the light-emitting unit, the anode and cathode voltages of the light-emitting diodes in the LED diode array are the same, the light-emitting diodes are in a reverse biased state, and current is not allowed to pass through the light-emitting diodes. At this time, the first row and the first column of the LED diode array are not displayed.

The control principle of the remaining rows and columns of the LED diode array is the same as the above principle. It can be understood that by controlling the light-emitting diodes in different areas of the LED diode array through the control chip U1, the control chip U2 and the control chip U3, the LED diode array can achieve complex display effects and patterns for displaying different information.

As described above, the display circuit in this embodiment adopts an LED display circuit. In some other specific implementations, an LCD display circuit can be selected to replace the LED display circuit in this embodiment.

Preferably, the temperature detection circuit includes a thermistor RT, a resistor R1, a resistor R2, a resistor R3, a resistor R4 and a capacitor C5. One end of the thermistor RT is connected to the power supply circuit through the resistor R3, the other end of the thermistor RT is connected to pin 3 of the control chip U1 through the resistor R1. The node between the thermistor RT and the resistor R1 is connected to pin 4 of the control chip U1. The resistor R2 is connected in parallel at the two ends of the thermistor RT, the resistor R4 is connected in parallel at the two ends of the resistor R1. One end of the capacitor C5 is grounded, and the other end is connected to the node between the resistor R1 and the control chip U1.

Understandably, the thermistor RT is a component whose resistance value changes with temperature, and is used to detect the temperature of the external environment, and the detected temperature data is transmitted to the control chip U1. The control chip U1 sends a signal to the display circuit, the control chip U2 and the control chip U3 to control the light-emitting diode display at a specified position in the display circuit.

Preferably, the humidity detection circuit includes a humidity sensor RH, a resistor R32, a resistor R33, a resistor R34, a resistor R35, a resistor R36, a resistor R37 and a capacitor C30. One end of the humidity sensor RH is connected to pin 7 of the control chip U1 through the resistor R35, the other end of the humidity sensor RH is connected to pin 5 of the control chip U1 through the resistor R32. The node between the resistor R32 and the humidity sensor RH is connected to pin 6 of the control chip U1. The resistor R33 is connected in parallel at the two ends of the humidity sensor RH, the resistor R34 is connected in parallel at the two ends of the resistor R32. One end of the capacitor C30 is grounded, and the other end is connected to the node between the resistor R34 and the control chip U1. One end of the resistor R36 and the resistor R37 connected in parallel is connected to the node between the capacitor C30 and the control chip U1, and the other end is connected to pin 8 of the control chip U1.

Understandably, the humidity sensor is used to detect the humidity in the external environment and transmit the detected humidity data to the control chip U1. The control chip U1 sends a signal to the display circuit, the control chip U2 and the control chip U3 to control the light emitting diode display at a specified position in the display circuit.

Preferably, the circuit module also includes a long display circuit, which comprises a triode Q7, a resistor R13, a resistor R8 and a plurality of parallel light-emitting diodes LD1. The emitter of the triode Q7 is connected to the power supply circuit, the collector of the triode Q7 is connected to pin 26 of the control chip U1 through the resistor R8, and the base of the triode Q7 is connected to the plurality of parallel light-emitting diodes LD1 through the resistor R13.

Understandably, by default, the control chip U1 outputs a high level to the collector of the triode Q7, so that the triode Q7 is turned on, and the multiple light-emitting diodes connected in parallel in the light-emitting diode LD1 are displayed. The long display circuit is used to indicate the current working state of the circuit, such as indicating whether the current circuit module is connected to the terminal device, whether the WIFI module in the wireless communication circuit is working normally, etc.

Preferably, the circuit module also includes a buzzer circuit, which comprises a field-effect transistor Q6, a resistor R21, a resistor R38 and a buzzer. The source of the field-effect transistor Q6 is grounded, the gate of the field-effect transistor Q6 is connected to pin 28 of the control chip U1 through the resistor R38. The drain of the field-effect transistor Q6 is connected to the buzzer through the resistor R21, and the buzzer is connected to the power supply circuit.

Understandably, the field-effect tube Q6 is used as an electronic switch to control the conduction and cutoff of the buzzer. When the buzzer needs to sound, the control chip U1 outputs a high level to the gate of the field-effect tube Q6, so that the field-effect tube Q6 is turned on, and the current flows through the buzzer to make it vibrate and sound; when the buzzer needs to stop sounding, the control chip U1 outputs a low level to the gate of the field-effect tube Q6, the field-effect tube Q6 is turned off, the current is cut off, and the buzzer stops vibrating. In actual applications, users can set the alarm function through the terminal device, and cooperate with the clock circuit inside the control chip U1. When the preset time is reached, the buzzer vibrates and sounds to remind the user.

Preferably, the circuit module also includes a button circuit, which comprises a button SET, a button UP, a button DOWN, a resistor R17, a resistor R18, a resistor R19 and a capacitor C29. One end of the button SET is connected to the power supply circuit, and the other end is connected to the pin 27 of the control chip U1. The button UP is connected in parallel to the two ends of the button SET, and the button DOWN is connected in parallel to the two ends of the button SET. The resistor R17 is connected in series with the button UP, and the resistor R18 is connected in series with the button DOWN. One end of the resistor R19 is grounded, and the other end is connected to the node between the button SET and the control chip U1. One end of the capacitor C29 is grounded, and the other end is connected to the node between the button SET and the control chip U1.

Understandably, the button SET, the button UP, and the button DOWN refer to three different function buttons, which are determined according to the specific equipment requirements. When the button circuit is applied to a weather station, the button SET represents the menu function, allowing users to select the time, date, and temperature unit. The button UP and the button DOWN indicate that the cursor moves up or down.

Preferably, the circuit module also includes a touch circuit, and the touch circuit comprises a touch chip U5 and an indicator light. The model of the touch chip U5 is TTP223, and pin 5 of the touch chip U5 is connected to the power supply circuit, pin 6 of the touch chip U5 is grounded, pin 1 of the touch chip U5 is connected to pin 19 of the control chip U1, pin 2 of the touch chip U5 is grounded, pin 3 of the touch chip U5 is connected to the indicator light, and pin 4 of the touch chip is used as a configuration pin and connected to one end of the capacitor C10, and the other end of the capacitor C10 is connected to the node between pin 2 of the touch chip U5 and the ground.

Understandably, the pin 4 of the touch chip U5 is connected to a low level, and the output high level is valid, that is, when a touch is detected, the output pin, that is, the pin 1 of the touch chip U5, will output a high level to the control chip U1. By burning a preset code to the control chip U1, when the control chip U1 detects that users triggers the touch chip U5, the display brightness of the light-emitting diode in the light-emitting circuit can be regulated.

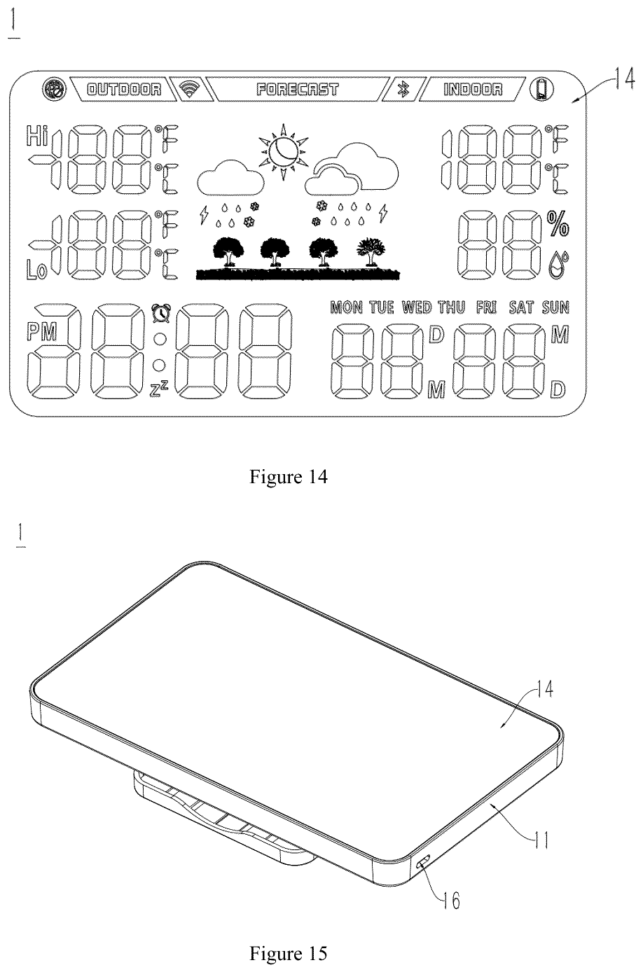

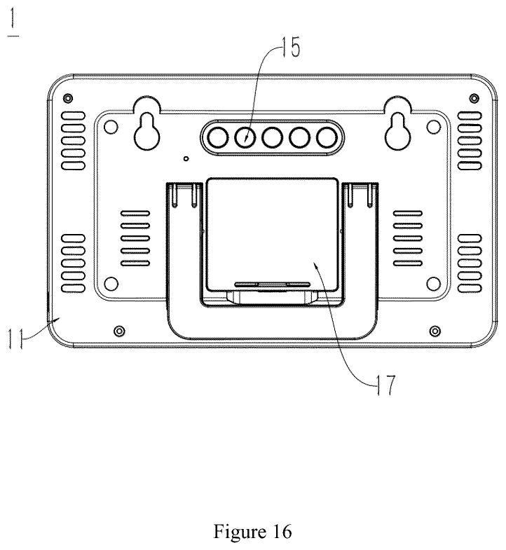

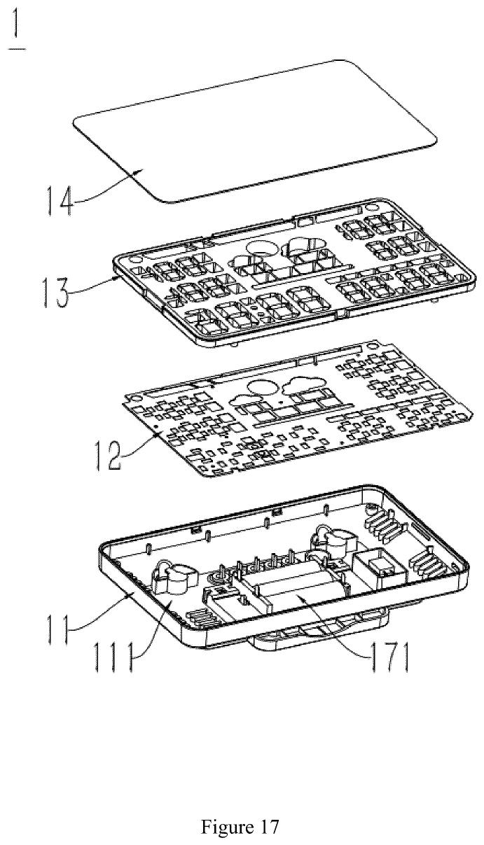

Referring to FIGS. 14 to 17, this embodiment also comprises a weather station 1. The weather station 1 comprises a cover 11, the cover 11 has an inner cavity 111, a circuit board 12 is arranged in the inner cavity 111, and the circuit board 12 has the above-mentioned circuit module welded thereon. LED segment displays 13 are arranged above the circuit board 12, a display circuit is disposed inside the LED segment displays 13, and different characters are displayed by controlling the brightness of each light-emitting diode in the LED segment displays 13.

Preferably, a facet 14 is provided above the LED segment displays 13. In this embodiment, the facet 14 is made of PET material, which has the property of light transmission. The characters displayed on the LED segment displays 13 can be observed by users through the facet 14. The facet 14 made of PET material can improve the optical performance of the LED segment displays 13 and provide users with a wide and bright visual effect; at the same time, the facet 14 can serve as a protective film to protect the surfaces of the LED segment displays 13 from scratches, so as to extend the service life of the LED segment displays 13.

Understandably, the control chip U1, the control chip U2 and the control chip U3 in the circuit module are all welded on the circuit board 12. The control chip U1, the control chip U2 and the control chip U3 control the display circuit, so that the light-emitting diodes in different areas of the LED segment displays 13 can emit light and display different characters, which can be used to indicate the current time, date, temperature or humidity and other information.

Preferably, a plurality of buttons 15 are arranged at the bottom of the cover 11. In this embodiment, five buttons 15 are arranged, the three in the middle correspond to the three buttons 15 in the button 15 circuit, and the remaining two buttons 15 are reserved buttons 15. In actual applications, the reserved buttons 15 can be configured to perform different functions.

Preferably, a power port 16 is arranged on the cover 11, and the power port 16 is electrically connected to the circuit board 12. An external power supply device can be connected to provide an operation voltage for the circuit board 12 through a power cord adapted to the power port 16.

Preferably, a battery case 17 is arranged at the bottom of the cover 11, and a battery 171 is arranged inside the battery case 17. The battery 171 is electrically connected to the circuit board 12. The battery 171 has the function of storing electricity and can independently supply power to the circuit board 12.

In this embodiment, the weather station can select the power port 16 or the battery 171 as the power source, and can use the battery 171 independently to ensure that it can work normally without an external power source. The weather station has a built-in low-battery status monitoring of the battery 171 to remind users to replace the battery 171 in time. When powered by the battery 171, the weather station will automatically adjust the power consumption of some non-critical functions, such as reducing the brightness of the display screen, extending the data update interval, etc., to extend the use time of the battery 171.

The terminal device referred to in this embodiment may be a mobile smart device such as a mobile phone or a tablet computer. Here, taking a mobile phone as an example to explain the working principle of the weather station 1 in this embodiment:

The weather station 1 can access the same WIFI network as the mobile phone through its built-in wireless communication circuit. After the weather station 1 accesses the WIFI network, it can directly obtain the current time and weather data from the network and display the relevant characters through the LED segment displays 13. At the same time, the mobile phone and the weather station 1 in the same local area network can communicate with each other through the network, and the mobile phone can access the setting interface of the weather station 1 through the browser to set the weather station 1. For example, the region, time format, date format, temperature unit, and alarm clock displayed on the weather station 1 can be set through the mobile phone in the browser, and the weather station 1 can respond to the setting request from the mobile phone in the same network, and respond to adjust the characters displayed on the LED segment displays 13, which can meet the needs of users in different regions and with different habits, and has a wide range of applications.

The specific steps of using the weather station 1 include:
S1—connecting the weather station to the network;
S2—setting up the webpage;
S3—acquiring and displaying weather data.

Further, step S1 mainly includes:
S101—The terminal device turns on the wireless network search function, searches for and identifies the specific network signal sent by the weather station. The weather station will broadcast a default network in the initial state so that the terminal device can easily find it;
S102—After the terminal device is connected to the weather station network, it opens a specific webpage and enters the setting page of the weather station. In this page, users can enter the name and password of the local 2.4G WIFI and other information;
S103—After the weather station receives the network information sent by the terminal device, it parses and processes it through the built-in WIFI module, stores it in the corresponding configuration file, and tries to connect to the specified WIFI network. Once the connection is successful, the weather station will be in the same local area network as the terminal device, ready for subsequent settings and data transmission.

Before executing step S2, after the terminal device is successfully connected to the weather station, the terminal device automatically pops up a setting webpage or accesses the setting webpage of the weather station by inputting a specific URL through a browser.

Further, step S2 includes:
Network name and password settings: Users can modify the name and password of the WIFI network to which the weather station is connected as needed to better manage and protect the network connection;
Location settings: Users can enter the specific geographical location information of the weather station, such as city, region, etc. This helps the weather station obtain local weather data more accurately and provide more targeted information when displaying;
Display settings: Users can choose different display formats to display weather data according to their personal preferences and usage scenarios. For example, you can set the time and date display format, temperature unit, display brightness, etc. to meet the needs of different users;
Alarm setting: Users can set the alarm function on the webpage and select a specific time to remind users, making it easier for users to arrange their daily activities.

Further, step S3 mainly includes:
S301—After the weather station is successfully connected to the network, it establishes a connection with a professional weather data server through a network protocol. The weather station will periodically send requests to the server to obtain the latest time and weather data information;
S302—After being processed and analyzed, the acquired weather data is displayed on the LED segment displays according to the display format set by the user.

The LED segment displays use high-brightness, high-contrast LED lamp beads, which can provide clear and bright display effects in various ambient light conditions. At the same time, due to the characteristics of the LED segment displays display, its viewing angle is wider, and users can easily view weather information from different angles, and can obtain accurate data without facing the display screen.

It should be noted that after the user sets the weather station 1 through a mobile phone or other terminal device so that the weather station 1 is connected to a fixed network, the weather station 1 can independently connect to the network to synchronize time and weather, and display them on the LED segment displays 13, thereby improving the efficiency and accuracy of data updates; at the same time, the weather station 1 that has successfully connected to the fixed network no longer requires a terminal device as a bridge, thereby reducing dependence on users' operations, making the weather station 1 more independent and autonomous, and improving convenience of use.

To sum up, the weather station provided in this embodiment can provide users with a wide and bright visual effect by adopting simple LED segment displays 13 display interface; users can set the weather station only through a browser. In addition, the weather station can also be powered by a battery 171, so that it can maintain normal operation without an external power supply.

It could be understood that under the guidance of the above embodiments, those skilled in the filed can combine various implementation methods in the above embodiments to obtain technical solutions of multiple implementation methods.

The above description is only a preferred embodiment of the present application and is not to limit the present utility patent. Any modifications, equivalent substitutions and improvements made within the spirit and principles of the present application should be included in the protection scope of the present application.

1. A circuit module used in weather station, comprises a microcontroller, a display circuit, a humidity detection circuit, a temperature detection circuit, a power supply circuit and a wireless communication circuit; wherein the power supply circuit is electrically connected to the microcontroller and the wireless communication circuit; the microcontroller is electrically connected to the display circuit, the temperature detection circuit, the humidity detection circuit and the wireless communication circuit; the power supply circuit is used to provide an operation voltage for the wireless communication circuit and the microcontroller; the wireless communication circuit is used to connect the microcontroller and an external terminal device; the humidity detection circuit is used to detect humidity data in the environment and transmit the humidity data to the microcontroller; the temperature detection circuit is used to detect temperature data in the environment and transmit the temperature data to the microcontroller; and the microcontroller controls the opening and closing of the display circuit.

2. The circuit module used in weather station according to claim 1, wherein the microcontroller further comprises a control chip U1, a resistor R5, a capacitor C3, a capacitor C4 and a crystal oscillator Y1; the control chip U1 has 28 pins; pins 1 and 12 of the control chip U1 are connected to the power supply circuit; pin 18 of the control chip U1 is connected to the power supply circuit through the resistor R5; the node between pin 18 of the control chip U1 and the resistor R5 is connected to one end of the capacitor C4; other end of the capacitor C4 is grounded; pin 17 of the control chip U1 is grounded after passing through the capacitor C3, and the pin 17 of the control chip U1 is connected with the node between the capacitor C3 at one end of the crystal oscillator Y1; the other end of the crystal oscillator Y1 is connected to pin 16 of the control chip U1.

3. The circuit module used in weather station according to claim 2, wherein the wireless communication circuit comprises a wireless module and a capacitor C17; the wireless module has 35 pins; pin 3 of the wireless module is grounded after passing through the capacitor C17; the node between the capacitor C17 and pin 3 of the wireless module is connected to a power supply circuit; pin 8 of the wireless module is connected to pin 11 of the control chip U1; pin 18 of the wireless module is connected to pin 10 of the control chip U1; pin 19 of the wireless module is connected to pin 9 of the control chip U1.

4. The circuit module used in weather station according to claim 2, wherein the power supply circuit comprises a battery, a power port, a diode D1, a diode D2, a linear regulator and a buck converter; the input end of the power port is connected to an external power supply device; the output end transmits the voltage to the diode D1 and the linear regulator U6 and then is connected to the control chip U1; the cathode of the battery is grounded, and the anode of the battery is connected to the control chip U1 after passing through the diode D2 and the linear regulator.

5. The circuit module used in weather station according to claim 4, wherein the power supply circuit also comprises a buck converter U8 and a capacitor C20; the node between the diode D1 and the linear regulator U6 is connected to the input end of the buck converter U8; the output end of the buck converter U8 is connected to the wireless communication circuit; one end of the capacitor C20 is connected to the node between the diode D1 and the buck converter U8, and other end of the capacitor C20 is grounded.

6. The circuit module used in weather station according to claim 2, wherein the temperature detection circuit comprises a thermistor RT, a resistor R1, a resistor R2, a resistor R3, a resistor R4 and a capacitor C5; one end of the thermistor RT is connected to the power supply circuit through the resistor R3; other end of the thermistor RT is connected to pin 3 of the control chip U1 through the resistor R1; the node between the thermistor RT and the resistor R1 is connected to pin 4 of the control chip U1; the resistor R2 is connected in parallel to two ends of the thermistor RT; the resistor R4 is connected in parallel to two ends of the resistor R1; one end of the capacitor C5 is grounded, and other end is connected to the node between the resistor R1 and the control chip U1.

7. The circuit module used in weather station according to claim 2, wherein the 2 humidity detection circuit comprises a humidity sensor RH, a resistor R32, a resistor R33, a resistor R34, a resistor R35, a resistor R36, a resistor R37 and a capacitor C30; one end of the humidity sensor RH is connected to pin 7 of the control chip U1 through the resistor R35, other end of the humidity sensor RH is connected to pin 5 of the control chip U1 through the resistor R32; the node between the resistor R32 and the humidity sensor RH is connected to pin 6 of the control chip U1; the resistor R33 is connected in parallel to two ends of the humidity sensor RH; the resistor R34 is connected in parallel to two ends of the resistor R32; one end of the capacitor C30 is grounded, and other end is connected to the node between the resistor R34 and the control chip U1; one end of the resistor R36 and the resistor R37 connected in parallel is connected to the node between the capacitor C30 and the control chip U1, and other end is connected to pin 8 of the control chip U1.

8. The circuit module used in weather station according to claim 2, wherein the circuit module also comprises a buzzer circuit; and the buzzer circuit further comprises a field-effect transistor Q6, a resistor R21, a resistor R38 and a buzzer; the source of the field-effect transistor Q6 is grounded, the gate of the field-effect transistor Q6 is connected to pin 28 of the control chip U1 through the resistor R38, the drain of the field-effect transistor Q6 is connected to the buzzer through the resistor R21; and the buzzer is connected to the power supply circuit.

9. A weather station, comprises a cover, wherein the cover has an inner cavity; a circuit board is arranged in the inner cavity; the circuit board is provided with the circuit module as claimed in any one of claims 1 to 8; LED segment displays are arranged above the circuit board; a facet is arranged above the LED segment displays.

10. A weather station according to claim 9, wherein a battery case is arranged at the bottom of the cover; a battery is arranged inside the battery case, and the battery is electrically connected to the circuit board.
